(19) United States
(12) Patent Application Publication
(10) Pub. No.: US 2013/0228622 A1
(43) Pub. Date: Sep. 5, 2013

(54) MINIMIZED-WEAR MAGNETIC READ AND/OR WRITE HEAD

(71) Applicants: Karl-Rudolf Hopt, Rottweil (DE); Peter Gluche, Bellenberg (DE)

(72) Inventors: Karl-Rudolf Hopt, Rottweil (DE); Peter Gluche, Bellenberg (DE)

(73) Assignees: GFD Gesellschaft fur Diamantprodukte mbH, Bellenberg (DE); ddm hopt + schuler GmbH & Co. KG, Rottweil (DE)

(21) Appl. No.: 13/884,703

(22) PCT Filed: May 27, 2011
(86) PCT No.: PCT/EP2011/058716

§ 371 Date: May 10, 2013

(30) Foreign Application Priority Data
Nov. 10, 2010 (DE) 102010043694.1

(51) Int. Cl. G06K 7/08

(52) U.S. Cl. CPC G06K 7/083
USPC 235/449

(57) ABSTRACT

In a magnetic read and/or write head (1) for exchanging signals with a magnetic data medium (2), according to the invention a protective diamond foil (10) is fixed, in particular adhered, to a housing wall (3) on which the magnetic data medium (2) is guided in a sliding manner in order to protect the housing wall (3) against abrasion wear and thereby to increase the life of the magnetic read and/or write head (1).

### CROSS REFERENCE TO RELATED APPLICATIONS

The present application is a 371 of International application PCT/EP2011/058716, filed on May 27, 2011, and designating the U.S., which claims priority under 35 U.S.C. §119 to German Patent Application No. 10 2010 043 694.1, filed on Nov. 10, 2010. The contents of the prior applications are hereby incorporated by reference in their entirety.

### TECHNICAL FIELD

The present invention relates to a magnetic read and/or write head for exchanging signals with a magnetic data medium, comprising a housing wall on which the magnetic data medium is guided in a sliding manner.

### BACKGROUND

Magnetic read and/or write heads of this type, which are also referred to as magnetic heads, are well known.

For writing on a magnetic storage medium, such as e.g. a magnetic strip card, the magnetic head of a magnetic strip card reader functions as an electromagnet and magnetizes the magnetically hard layer material of the magnetic strip in the rhythm of information. During reading, this magnetization of the magnetic strip for its part induces a small voltage in the magnetic head, which is converted into electrical signals and further processed.

The magnetic heads consist of ferrous (ferromagnetic) materials, which are relatively soft. The magnetic heads are curved, i.e. have a three-dimensional surface structure and can additionally also consist of different materials. Since the magnetic strip is formed from a harder material (iron oxide) than the metal magnetic head housing, the magnetic head housing wall, on which the magnetic data medium is guided in a sliding manner for data exchange, is abraded with time such that the magnetic heads are subjected to great wear and tear. The frictional contact with the relatively hard magnetic strip thus results in great abrasion wear of the magnetic head. In dependence on the field of use (offices, petrol stations etc.) the wear of the magnetic head housing wall is that great such that the requirements stated in the data sheet can, if at all, only hardly be fulfilled during the service life of the magnetic head.

DLC (diamond like carbon) coatings on magnetic storage media of hard disks have already been used to reduce abrasion wear. Up to now, it has only been possible to provide planar structures, such as hard disks, with DLC coatings. In contrast thereto, three-dimensional structures cannot be coated since the ion bombardment required for coating in order to generate the sp3 bonds (which cause the hardness) does not take place on the substrate surface. For this reason, the layer changes its morphology and its physical properties in dependence on the surface geometry. However, DLC layers can be easily used on planar surfaces. Moreover, deposition of a DLC layer at relatively low temperatures (substrate temperature of approximately 100° C.) is possible, however, it does not adhere to all types of substrates. The transverse rupture stress of a DLC layer is only 1-2 GPa. Since magnetic heads are curved and additionally must not be subjected to temperatures of more than 80° C., DLC coating cannot be used as a wear protection layer for magnetic heads.

Diamond coatings are well-established for cutting tools and as abrasion wear protection layer for carbide tools, but can be deposited only to a very limited number of different substrates. A ferrous magnetic head cannot be coated with diamond for the following reasons:
substrate temperature is too high (approximately 600-900° C.);
since there are no absolutely matching substrate materials (i.e. α_{diamond}˜α_{substrate}) the low thermal expansion coefficient of diamond ( α_{diamond}≈1 ppm/K) causes thermally induced stress between the substrate material and the diamond layer, which results in delamination in the worst case.
the high portion of methane and hydrogen radicals diffuses into the substrate material causing structural changes, which in the case of ferrous materials usually results in that the material becomes brittle.

For this reason, it is the object of the present invention to protect the housing wall of a magnetic read and/or write head of the above-mentioned type, on which housing wall the magnetic data medium is guided in a sliding manner, against abrasion wear, thereby increasing the service life.

### SUMMARY

This object is achieved in accordance with the invention in that a protective diamond foil (or film) is fixed, in particular adhered, to the housing wall, the wear resistance of which is consequently higher than that of the housing wall.

Experiments have shown that the inventive protective diamond foil significantly reduces the wear of the housing wall, thereby correspondingly increasing the service life of the magnetic head.

The protective diamond foil is preferably formed by a microcrystalline and/or nanocrystalline diamond layer, which was e.g. produced on a planar or pre-structured sacrificial substrate and is then applied to the housing wall of the magnetic head through a frictional connection. When the housing wall is curved, the diamond layer must be bent to be adapted to the housing wall. In order to prevent the diamond layer from being broken, it must have a low modulus of elasticity and high transverse rupture stress. The nanocrystalline diamond films “Diamaze 810” and “Diamaze 900” of the company Diamaze Microtechnology SA have turned out to be particularly suitable in this case, which have a hardness of approximately 77±8 GPa and 68±5 GPa, respectively, and have no influence on the detection of magnetic signals by the sensor.

The protective diamond foil is preferably formed by a diamond layer produced through chemical vapor deposition. A CVD diamond layer of this type can be deposited in the most different configurations, which are characterized by their grain size, the orientation of the grains relative to the substrate (texture), the sp and sp2 portion in the layer. A nanocrystalline diamond layer with an average grain size <10 nm and a sp/sp2 portion of <10% has turned out to be most suitable.

The average grain size of the nanocrystalline diamond layer is preferably in a range between approximately 1 and approximately 100 nm, particularly preferred between approximately 1 and approximately 10 nm. In accordance with the invention, a nanocrystalline diamond is defined as a diamond layer, the crystalline domains of which have an average grain size d50 of ≦100 nm. This definition requires that the dimension of each individual crystallite of at least 50% of the crystallites is ≦100 nm. The nanocrystalline diamond layer is therefore characterized by an extremely high homogeneity of the crystallites in contrast to polycrystalline diamond layers. The use of diamond layers with average grain sizes in the range between 1 and 100 nm and, with particular preference, in the range between 1 and 10 nm, also has an advantageous effect on the surface roughness, since the latter also decreases with decreasing grain size. When the protective diamond foil and the magnetic strip are brought into mating contact, it is expected that the abrasion wear of the magnetic strip is reduced due to the inventive reduced surface roughness. This also results in that fewer abrasion products soil the overall system, usually in the form of abrasive dust, thereby extending the cleaning cycles. The diamond layer surfaces can, of course, also be mechanically post-processed by means of downstream polishing, e.g. through mechanical slide grinding or drag finishing. Other possibilities include ultrasonic-assisted grinding in abrasive suspensions of diamond particles or ceramic abrasives, such as e.g. Al2O3 or SiC or the like, plasma polishing in oxygen and/or chlorine—and/or fluorine-containing plasmas and/or ion-assisted processing steps, such as RIE (reactive ion etching), ion milling or other ion beam-assisted methods. In this way, one obtains an advantageous surface roughness of between 1 and 50 nm rms, with particular advantage a surface roughness <7 nm rms.

The gradient of the average grain size of the nanocrystalline diamond layer, measured in the direction of thickness of the nanocrystalline diamond layer, is moreover preferably approximately <300%, preferably approximately <100%, with particular preference approximately <50%. With such a gradient, the average grain size diameter of the nanocrystalline domains of the diamond layer is distributed relatively uniformly or particularly uniformly throughout the entire layer thickness, i.e. the grain sizes on one side of the diamond layer are approximately equal to those on the other side of the diamond layer. It is particularly preferred in this connection when the nanocrystalline domains of the diamond layer are almost homogeneous or completely homogeneous. The gradient is determined by detecting the average grain size diameter d50 on one side of the diamond layer and correlating it with the average grain size diameter on the opposite side of the diamond layer. For example, the average grain size distribution on the surface of the respective diamond layer can be used for this purpose.

The portion of sp and sp2 bonds of the nanocrystalline diamond layer is preferably between approximately 0.5 and approximately 10%, preferably between approximately 2 and approximately 9%, particularly preferred between approximately 3 and approximately 8%. It is moreover advantageous when the crystallites of the fine-crystalline diamond layer preferably have grown in <100>, <110>, <111> and/or <111220> direction, i.e. a texture is present. This can result from the production process, in which the growth speed of certain crystal directions can be specifically favoured. This anisotropic texture of the crystallites also has a positive influence on the mechanical properties.

The nanocrystalline diamond layer preferably has a transverse rupture stress of at least approximately 2 GPa, preferably of at least approximately 4 GPa, particularly preferred of at least approximately 5 GPa such that the protective diamond foil can be adapted to a curved housing wall of the magnetic head.

With respect to a definition of the transverse rupture stress, reference is made to the following citations:
R. Morrell et al., Int. Journal of Refractory, Metals & Hard Materials, 28 (2010), page 508-515;
R. Danzer et al., “Technische keramische Werkstoffe” (technical ceramic materials) published by J. Kriegesmann, HvB Verlag, Ellerau, ISBN 978 3 938595 00 8, chapter 6.2.3.1—“Der 4-Kugelversuch zur Ermittlung der biaxialen Biegefestigkeit spröder Werkstoffe” (The 4-ball test for determining the biaxial transverse rupture stress of brittle materials).

The transverse rupture stress is thereby determined through statistic evaluation of breaking tests e.g. in a B3B load test in accordance with the above-mentioned citations. It is defined as the breaking stress, at which the probability of fracture is 63%.

The nanocrystalline diamond layer moreover preferably has a modulus of elasticity of less than approximately 900 GPa, particularly preferred of less than approximately 700 GPa. The use of nanocrystalline diamond layers with the grain sizes as stated above results in that the modulus of elasticity is also considerably reduced compared to polycrystalline diamond layers. Due to the curved magnetic head, the protective diamond foil is pretensioned and therefore acts as a spring element which tends to return into its initial position (planar state). A lower modulus of elasticity of the protective diamond foil automatically results in smaller restoring forces in case of mechanical load, and therefore in a smaller load on the adhesive. Since the grain boundary volume increases in relation to the crystal volume (grain volume) with decreasing grain size of the diamond layer, and the bonds at the grain boundary are generally weaker than in the crystal (grain), the macroscopically determined modulus of elasticity correlates diametrally with the average grain size. Typical values for the modulus of elasticity of nanocrystalline diamond layers (grain size approximately 10 nm) are in a range of <900 GPa and with particular preference <700 GPa.

The protective diamond foil preferably has a material thickness of less than approximately 100 μm, preferably less than approximately 20 μm, particularly preferred less than approximately 15 μm.

The invention also relates to a magnetic strip reader comprising a minimized-wear magnetic head of the above-described design for data exchange with a magnetic data medium.

Further advantages of the invention can be extracted from the description, the claims and the drawing. The features mentioned above and below can be used individually or collectively in arbitrary combination. The embodiments illustrated and described are not to be understood as an exhaustive enumeration but have exemplary character for describing the invention.

### DESCRIPTION OF DRAWINGS

FIG. 1 shows the inventive magnetic head;

FIG. 2 shows a magnetic strip card reader comprising the inventive magnetic head; and

FIGS. 3a-3d show different embodiments of the inventive magnetic head.

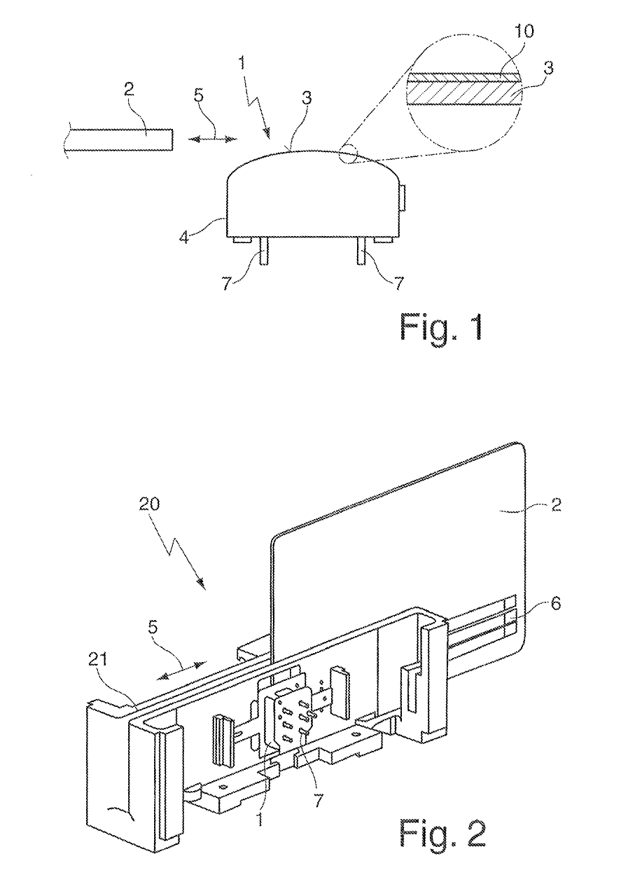

### DETAILED DESCRIPTION

The magnetic read and/or write head (referred to as “magnetic head” below) 1 is used to exchange data with a magnetic strip card 2, which is guided in a sliding manner on a convexly curved magnetic head housing wall 3 of the metal magnetic head housing 4 for data exchange (double arrow 5). For writing on the magnetic strip 6 (FIG. 2) of the magnetic strip card 2, the magnetic head 1 functions as an electromagnet and magnetizes the magnetically hard layer material of the magnetic strip 6 in the rhythm of information. During reading, this magnetization of the magnetic strip 6 for its part induces a small voltage in the magnetic head 1, which is converted into electrical signals and further processed. The electrical connections of the magnetic head 1 are designated by 7.

The magnetic strip 6 of the magnetic strip card 2 is formed from a harder material (ferrous oxide) than the metal magnetic head housing wall 3. In order to reduce wear of the magnetic head housing wall 3 by the magnetic strip card 2, which would otherwise occur, and thereby increase the service life of the magnetic head 1, a protective diamond foil 10 of nanocrystalline diamond is adhered to the magnetic head housing wall 3, the wear resistance of which is higher than that of the magnetic head housing wall 3. The protective diamond foil 10 has an overall foil thickness of merely approximately 5 μm to approximately 20 82 m and has no or only little influence on the magnetic read and write operation of the magnetic head 1. The nanocrystalline diamond films “Diamaze 810” and “Diamaze 900” of the company Diamaze Microtechnology SA have turned out to be particularly suited in this case.

FIG. 2 shows a magnetic strip card reader 20 with a guiding slot 21 for swiping a magnetic strip card 2. The minimum-wear magnetic head 1 is arranged in one of the two guiding sides of the guiding slot 21 for data exchange with the magnetic strip card 2.

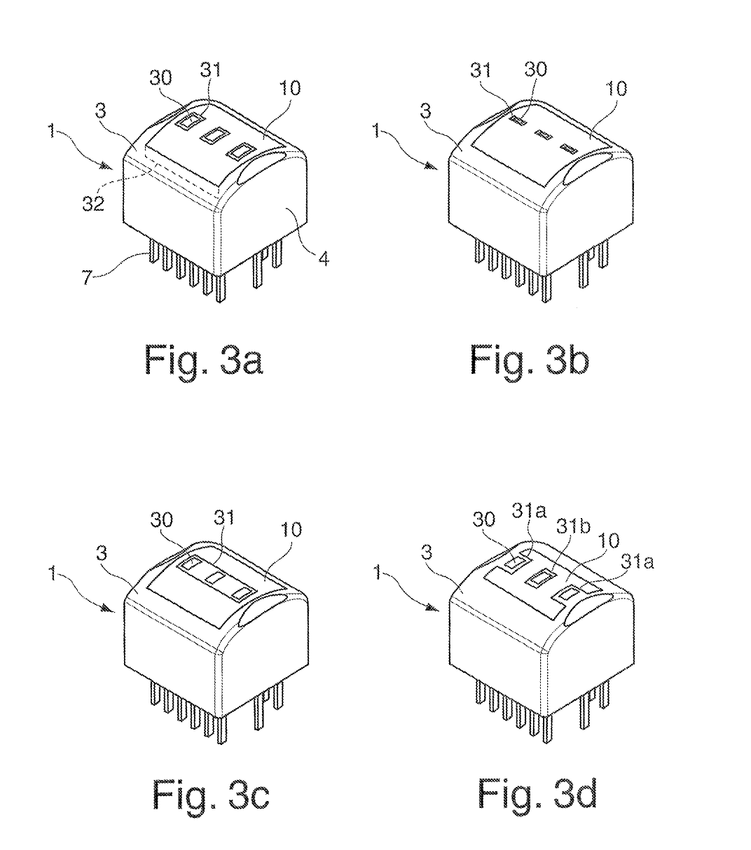

FIGS. 3a-3d show different embodiments of protective diamond foils 10 which are glued to the magnetic head 1. On its convexly curved magnetic head housing wall 3, the magnetic head 1 has three magnet coils 30 for data exchange with a three-track magnetic strip 6.

The protective diamond foil 10 illustrated in FIG. 3a is rectangular and has three cut-outs 31, the dimensions of which correspond to those of the magnet coils 30. The magnet coils 30 are therefore not covered by the protective diamond foil 10. However, in the protective diamond foil 10 illustrated in FIG. 3b, the three cut-outs 31 are smaller than the dimensions of the magnet coils 30. The magnet coils 30 are therefore partially covered by the protective diamond foil 10.

The protective diamond foil 10 illustrated in FIG. 3c is rectangular and has one single central cut-out 31, within which the three magnet coils 30 are located. The magnet coils 30 are therefore not covered by the protective diamond foil 10.

The protective diamond foil 10 illustrated in FIG. 3d is designed in the shape of an H with two laterally open recesses 31 a for the two outer magnet coils 30 and with a central recess 31 b for the central magnet coil 30. The magnet coils 30 are not covered by the protective diamond foil 10.

In case of a magnetic read head, the protective diamond foil 10 can be simply glued on a commercially available magnetic head 1, since the separation between the magnetic strip card 2 and the magnet coil 30, which is now increased by approximately 20 μm, does not impair the read operation.

In contrast thereto, in case of a magnetic write head, a separation between the magnetic strip card 2 and the magnet coil 30, which is increased by the foil thickness of approximately 20 μm, would impair the write operation or even render it impossible. In these cases, the protective diamond foil is at least partially lowered into a depression 32 of the housing wall 3 indicated in FIG. 3a, in order not to increase the separation between the magnetic strip card 2 and the magnet coil 30.

In conclusion, the individual method steps for producing the nanocrystalline protective diamond foil 10 are described:

1. Production of a nanocrystalline diamond layer (diamond foil) on a sacrificial substrate of silicon by means of chemical vapor deposition (preferably CVD)

For example, in the hot filament method, a vapor phase consisting of 1 to 5 vol. % CH4 and 95 to 99 vol. % hydrogen is activated in a vacuum chamber by means of hot filaments, e.g. tungsten wires. The wire temperature is in a range between 1800° C. and 2400° C. When the separation between the substrate and the wires is between 1 cm and 5 cm, a substrate temperature of 600° C. to 900° C. is established. The pressure of the gas atmosphere is between 3 mbar and 30 mbar. The nanocrystalline diamond layer is thereby deposited onto the substrate.

Alternative substrate materials are:

a) Semimetals, preferably carbon, silicon or germanium;

b) metal materials, preferably Fe, Ni, Cr, Co, Cu, Mn, V, Ti, Sc, W, Ta, Mo, Nb, Pt, Au, Rh;

c) alloys of the metal materials mentioned in b);

d) metal carbides of the refractory metals Ti, Ta, W, Mo, Ni;

e) compound materials of ceramic materials in a metal matrix (cermets), hard metals, sintered carbide hard metals, such as e.g. cobalt or nickel-bound tungsten carbides or titanium carbides;

f) ceramic materials containing carbon and/or nitrogen and/or boron and/or oxygen, such as e.g. silicon carbide, silicon nitride, boron nitride, titanium nitride, AlN, CrN, TiAlN, TiCN and/or TiB2, glass ceramics, sapphire;

g) carbon, such as e.g. graphite, monocrystalline diamond, polycrystalline diamond, nanocrystalline diamond.

2. Structuring (cutting) of the nanocrystalline diamond layer, preferably still located on the substrate:

a) by means of laser (cutting of the blank);

b) by means of reactive ion etching or ion milling, focused ion beam. In this connection, the definition of the geometry can be performed by a shadow mask (reusable, if necessary) or by a photolithographic mask. The etching gases contain Ar, O2 and/or CF4, CL2, SF6;

c) water jet cutting.

3. (optional) Termination of the diamond surface (growth side) by means of plasma treatment

a) O-termination

b) F, H, OH termination

c) mixtures of the above-mentioned gases

Reason for termination: elimination of surface conductivities, modification of the surface tension for reducing the adhesion behavior of contaminations.

4. Removal of the diamond foil from the substrate preferably through chemical attack of the substrate (in the present case through KOH):

etching of the substrate in an aqueous alkaline solution, preferably KOH

alternatively mechanical delamination of the diamond layer

introduction of delamination layers (which are chemically dissolved at a later point in time) such as e.g. SiO2.

5. (optional) termination of the diamond surface (substrate side) with oxygen (e.g. through plasma treatment in oxygen and/or hydrogen and/or fluorine-containing plasmas).

a) alternatively O-termination

b) F, H, OH termination

c) mixtures of the above-mentioned gases

Reason for termination: elimination of surface conductivities, modification of the surface tension for reducing the adhesion behavior of contaminations.

6. Application of an adhesive layer onto the magnetic head 1 and/or the protective diamond foil 10

a) by means of spin coating

b) by means of dispensers

c) by means of a transfer method

Suitable is a 2 component epoxy adhesive with low degassing behavior and corresponding temperature stability. Other adhesives are also feasible, such as e.g. adhesives on the basis of cyanide acrylates.

7. Hardening of the Magnetic Head 1 with Glued-On Protective Diamond Foil 10 in the Furnace at Maximally 80° C.

1-14. (canceled)

15. A magnetic read and/or write head for exchanging signals with a magnetic data medium, comprising;
a housing wall on which the magnetic data medium is guided in a sliding manner; and
a protective diamond foil adhered to the housing wall.

16. The magnetic read and/or write head according to claim 15, wherein the protective diamond foil is a diamond layer produced through chemical vapor deposition.

17. The magnetic read and/or write head according to claim 15, wherein the protective diamond foil is a microcrystalline and/or nanocrystalline diamond layer.

18. The magnetic read and/or write head according to claim 17, wherein the nanocrystalline diamond layer has an average grain size in a range between approximately 1 and approximately 100 nm.

19. The magnetic read and/or write head according to claim 17, wherein the average grain size of the nanocrystalline diamond layer has a gradient, measured in a direction of thickness of the nanocrystalline diamond layer, that is approximately <300%.

20. The magnetic read and/or write head according to claim 17, wherein a portion of sp and sp2 bonds of the nanocrystalline diamond layer is between approximately 0.5 and approximately 10%.

21. The magnetic read and/or write head according to claim 17, wherein the nanocrystalline diamond layer has a transverse rupture stress of at least approximately 2 GPa.

22. The magnetic read and/or write head according to claim 17, wherein the nanocrystalline diamond layer has a modulus of elasticity of less than approximately 900 GPa.

23. The magnetic read and/or write head according to claim 17, wherein the nanocrystalline diamond layer has a surface roughness in a range between approximately 1 nm and approximately 50 nm.

24. The magnetic read and/or write head according to claim 15, wherein the protective diamond foil has a material thickness of less than approximately 100 μm.

25. The magnetic read and/or write head according to claim 24, wherein the protective diamond foil has a material thickness of less than approximately 20 μm.

26. The magnetic read and/or write head according to claim 25, wherein the protective diamond foil has a material thickness of less than approximately 15 μm.

27. The magnetic read and/or write head according to claim 15, wherein the housing wall is curved.

28. The magnetic read and/or write head according to claim 15, wherein the housing wall has a depression and the protective diamond foil is at least partially lowered into the depression of the housing wall.

29. The magnetic read and/or write head according to claim 15, and further comprising magnet coils, wherein the protective diamond foil comprises recesses in an area of the magnet coils.

30. A magnetic strip card reader, comprising a magnetic read and/or write head for exchanging signals with a magnetic data medium, the magnetic read and/or write head comprising a housing wall on which the magnetic data medium is guided in a sliding manner, and a protective diamond foil adhered to the housing wall.

31. The magnetic strip card reader according to claim 30, wherein the protective diamond foil is a diamond layer produced through chemical vapor deposition.

32. The magnetic strip card reader according to claim 30, wherein the protective diamond foil is a microcrystalline and/or nanocrystalline diamond layer.

33. The magnetic strip card reader according to claim 30, wherein the protective diamond foil has a material thickness of less than approximately 100 μm.

34. The magnetic read and/or write head according to claim 33, wherein the protective diamond foil has a material thickness of less than approximately 20 μm.

35. The magnetic read and/or write head according to claim 34, wherein the protective diamond foil has a material thickness of less than approximately 15 μm.

36. The magnetic strip card reader according to claim 30, wherein the housing wall is curved.

37. The magnetic strip card reader according to claim 30, wherein the housing wall has a depression and the protective diamond foil is at least partially lowered into the depression of the housing wall.

38. The magnetic strip card reader according to claim 30, wherein the magnetic read and/or write head has magnet coils, and the protective diamond foil comprises recesses in an area of the magnet coils.
